(19) United States
(12) Patent Application Publication
(10) Pub. No.: US 2007/0115424 A1
(43) Pub. Date: May 24, 2007

(54) PRESCRIPTION INSERT FOR SAFETY EYEWEAR AND CONVERSION KIT TO MAKE A PRESCIPTION INSERT INTO FUNCTIONAL EYEGLASSES

(75) Inventor: Laurent Froissard, Cranston, RI (US)

Correspondence Address: BARLOW, JOSEPHS & HOLMES, LTD., 101 DYER STREET, 5TH FLOOR, PROVIDENCE, RI, 02903, US

(73) Assignee: BACOU-DALLOZ EYE & FACE PROTECTION, INC., Smithfield, RI (US)

(21) Appl. No.: 11/466,783

(22) Filed: Aug. 24, 2006

Related U.S. Application Data
(60) Provisional application No. 60/737,924, filed on Nov. 18, 2005.

(51) Int. Cl. G02C 5/00

(52) U.S. Cl. 351/41

(57) ABSTRACT

An optical insert and kit for mounting the optical insert into a pair of protective eyewear and converting the optical insert into stand-alone pair of eyewear is disclosed. The optical insert has a frame with a left lens opening and a right lens opening. The left lens opening and the right lens opening are configured and arranged to receive a left lens and a right lens therein, respectively. A nose bridge support connects the left lens opening and the right lens opening of the frame together. The nose bridge support has a surface defining a central, vertically orientated, mounting slot therethrough. The central mounting slot is configured and arranged to cooperate with a prong of a mount to releasably couple the optical insert to the protective eyewear. The kit further includes a left temple bar and a right temple bar that are releasably coupled to the left and right sides of the frame, respectively, of the insert and a nose pad support that is releasably secured to the nose bridge structure to convert the optical insert into a stand-alone pair of eyewear.

### CROSS-REFERENCE TO RELATED APPLICATION

This application claims priority to earlier filed U.S. Provisional Application Ser. No. 60/737,924, filed Nov. 18, 2005, the contents of which are incorporated herein by reference.

### BACKGROUND OF THE INVENTION

1. Field of the Invention

The present invention relates generally to prescription inserts for use with safety eyewear and more particularly to a prescription insert that can be converted into fully functional prescription eyeglasses.

2. Background of the Related Art

The creation of safety eyewear and other masks that fit over a user's face has presented a problem to those that wear corrective eyeglasses for their vision. Typical corrective eyeglasses often will not fit underneath a mask, especially if any sort of seal around the face is required. To solve this problem, a variety of prescription inserts have been developed for insertion into goggles, masks and protective eyewear of all types.

Prior art prescription inserts typically include a pair of lenses suspended in a frame which has a structure for mounting the insert into a pair of safety eyewear or other goggles, such as scuba or diving masks. The configurations are numerous and each is designed for a specific mask or goggle. Because each prescription insert is designed for a particular a goggle or mask, one prescription insert can rarely be substituted for another. If the user has multiple sets of protective eyewear, the user will require multiple custom prescription inserts with each being specifically configured to fit each pair of protective eyewear. As a result, the user must keep multiple prescription inserts at great expense and inconvenience. Therefore, there is a need for a prescription insert that can be universally mounted into a variety of eyewear.

Moreover, prior art prescription inserts are not capable of being worn separately as a pair of stand-alone eyeglasses. If the user misplaces or leaves his or her regular eyeglasses at home, they cannot readily use the prescription insert as a replacement set of eyeglasses. Therefore, there is a need for a prescription insert that can be readily converted into a fully functional set of stand-alone eyeglasses.

### SUMMARY OF THE INVENTION

The present invention solves the problems of the prior art by providing a prescription insert having a nose bridge support with a central mounting slot that cooperates with a prong of a mount. The mount is an inexpensive wire or plastic structure that is configured and arranged to be snap-received over the lens or frame of a pair of safety eyewear. The prescription insert is held securely in place in the safety eyewear by sliding the mounting slot of the nose bridge support over the central prong of the mount.

The prescription insert can be easily converted into a pair of eyeglasses by attaching a pair of removable temple bars and a nose pad to the prescription insert.

Accordingly, among the objects of the present invention is the provision for a prescription insert that can be universally mounted in a variety of safety eyewear and other masks with an inexpensive mount.

Another object of the present invention is the provision for a prescription insert that can be easily converted into a pair of functional eyeglasses.

### BRIEF DESCRIPTION OF THE DRAWINGS

These and other features, aspects, and advantages of the present invention will become better understood with reference to the following description, appended claims, and accompanying drawings where:

FIG. 1 is a perspective view of the prescription insert of the present invention;

FIG. 2 is a top view of the prescription insert of the present invention;

FIG. 3 is a rear perspective view of the prescription insert of the present invention mounted to a unitary lens of a pair of safety eyewear;

FIG. 4 is a top view of the assembly depicted in FIG. 3;

FIG. 5 is a perspective view of the mount for the prescription insert of the present invention;

FIG. 6 is a rear perspective view of an alternative mounting arrangement for the prescription insert of the present invention;

FIG. 7 is a perspective view of an alternative embodiment of the mount for the prescription insert of the present invention;

FIG. 8 is a perspective view of the conversion kit for the prescription insert of the present invention;

FIG. 9 is an exploded view of the conversion kit for the prescription insert of the present invention;

FIG. 10 is a perspective view of an alternative embodiment of the conversion kit for a prescription insert of the present invention;

FIG. 11a is a close up view of the area circled in a dashed line in FIG. 10;

FIG. 11b is an exploded view of the close up view of the prescription insert and conversion kit of the present invention shown in FIG. 11a;

FIG. 12a is a close up view of a retaining catch for the alternative embodiment of the prescription insert and conversion kit of the present invention; and

FIG. 12b is a close up view of the retaining catch decoupled from the prescription insert and conversion kit of the present invention shown in FIG. 12a.

### DESCRIPTION OF THE PREFERRED EMBODIMENT

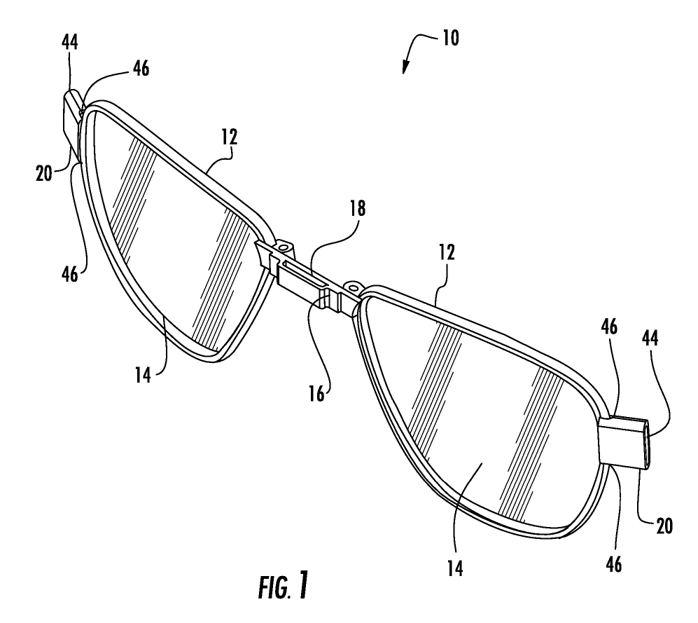

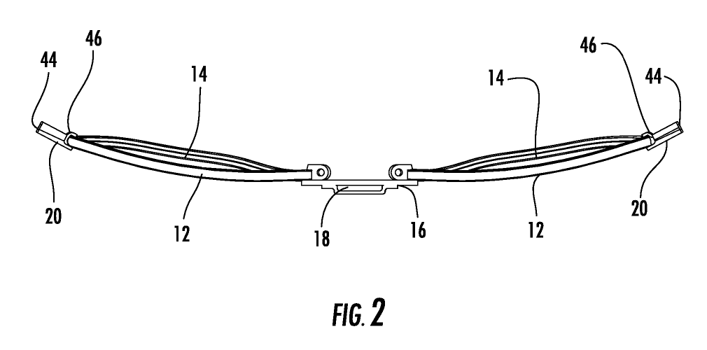

Referring to FIG. 1, the prescription insert of the present invention is shown generally at 10. The prescription insert 10 includes two wire frame openings 12 to securely hold left and right lenses 14 respectively. The frames 12 are held together by nose bridge support 16 that has a central mounting slot 18 (which is best seen in FIG. 2). At either outermost edge of the wire frame openings 12 of the prescription insert 10, are left and right temple bar mounting structures 20.

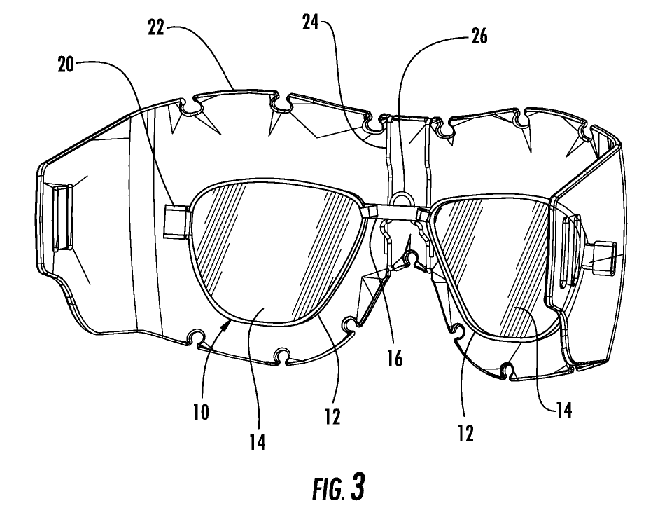

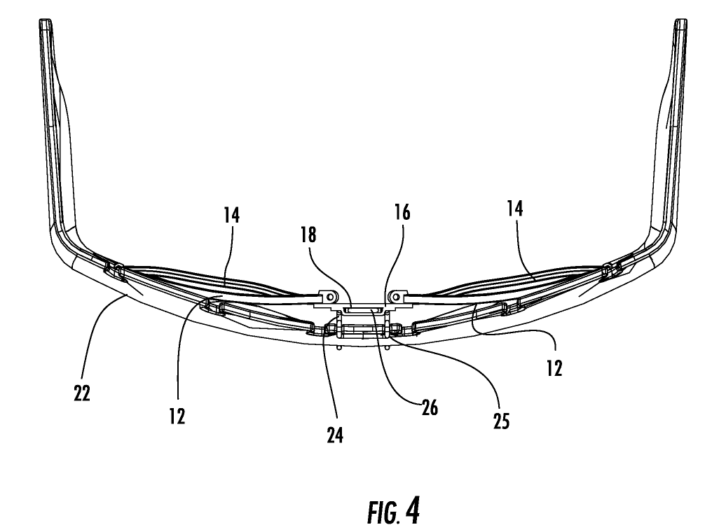

As seen in FIGS. 3-4, the prescription insert 10 of the present invention is mounted within a goggle shield 22 of a pair of safety eyewear on a mount 24 with a central prong 26. The mounting slot 18 on the nose bridge support 16 of the prescription insert is frictionally fit over the central prong 26 of the mounting structure 24, which securely holds the prescription insert 10 in place within the goggle shield 22.

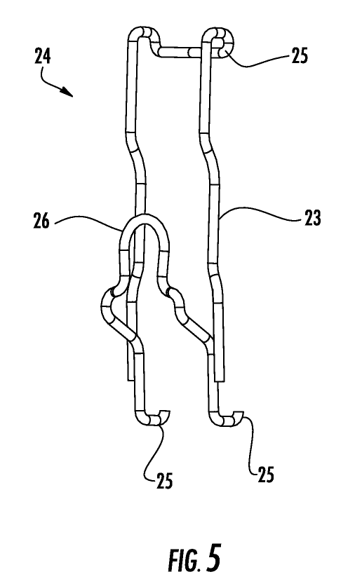

As seen in FIG. 5, the mounting structure 24 has a rigid body 23 made preferably of wire or plastic. The body 23 has hooks 25 at opposing ends of the body 23 configured and arranged to snap over the goggle shield 22 to hold the mounting structure 24 securely to the goggle. Projecting rearward from the body 23 of the mounting structure 24 is the central prong 26.

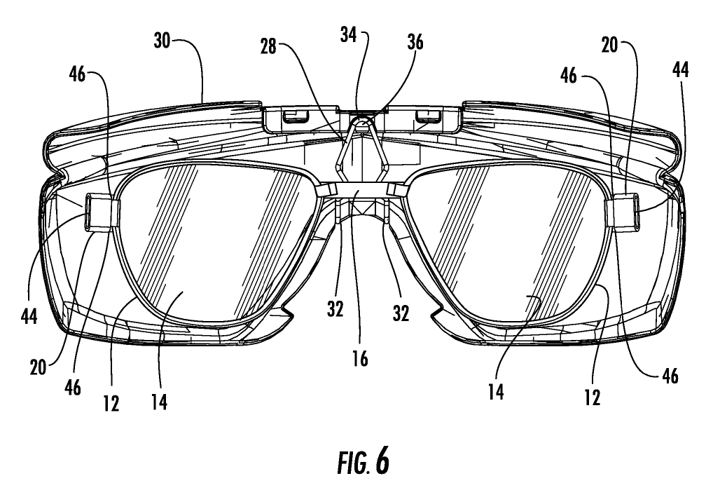

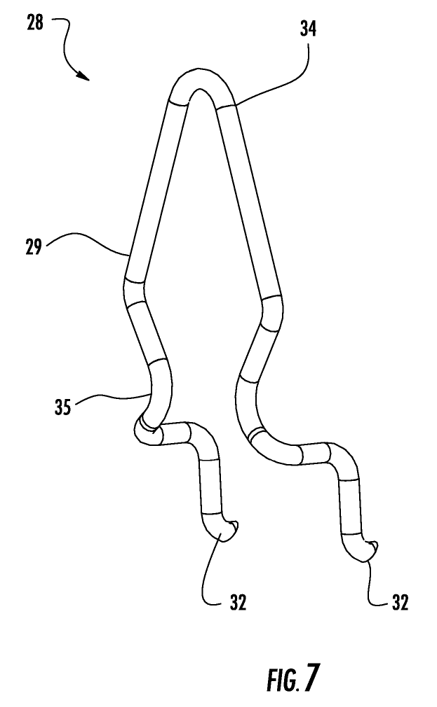

As shown in FIGS. 6-7, an alternative embodiment of the mount 28 is shown configured and arranged to fit to another type of goggle shield 30. In particular, the alternative mount 28 has a rigid wire or plastic body 29 with a pair of hooks 32 at the bottom portion of the body 29, which attach to the bottom edge of the goggle shield 30. The body 29 is curved to form a prong-shaped arch 34 with a narrowed neck portion 35, which interfits with the mounting slot 18 of the prescription insert 10. The top of arch 34 snap-fits over a projection 36 on the goggle shield 30 to securely hold the mount 28 to the goggle and prevent the prescription insert 10 from coming loose from the mount 28.

So long as the mount has a structure that snuggly fits within the mounting slot 18 of the prescription insert 10, the remainder of the mount can be easily configured to attach to a variety of goggles. As can be appreciated, the mounts in themselves are very inexpensive to manufacture. This feature enables a user to own a variety of mounts that are configured to fit a variety of goggles or masks, yet still only need to possess one prescription insert 10. Therefore, the user realizes significant savings by only having to purchase a single prescription insert 10 for use with a variety of protective eyewear and masks.

Although, the embodiments of the mounting structures shown depict the mounting structure as attaching to the goggle lens only, the mounting structure can be easily configured to mount to the goggle frame as well. As such, the included embodiments are by way of example and not of limitation.

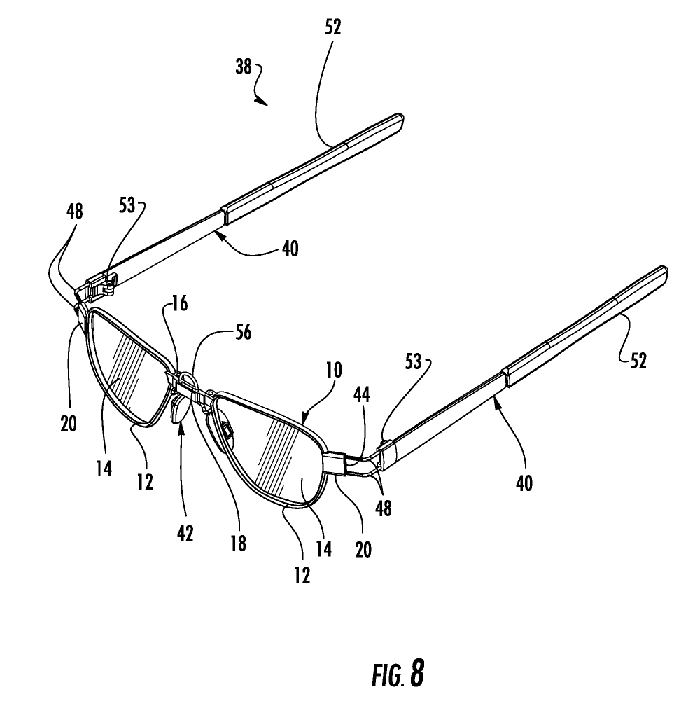

The prescription insert 10 also has the advantage of being easily converted into a functional pair of eyeglasses 38 as shown in FIG. 8. In particular, the prescription insert 10 is transformed into a functional pair of eyeglasses 38 by attaching left and right temple bars 40 and a nose pad structure 42 to the temple bar mounting structures 20 and nose bridge support 16, respectively. Referring back to FIGS. 1-2, the temple bar mounting structures 20 have a slot 44 and a pair of recesses 46 integrally formed thereon, which are critical to the attachment of the temple bars.

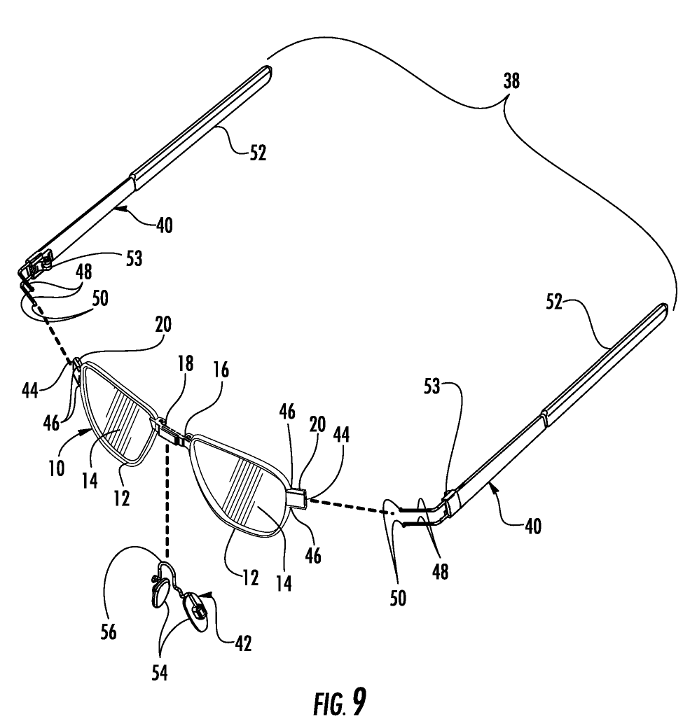

As more clearly seen in the exploded view in FIG. 9, the conversion kit for the prescription insert 10 includes left and right temple bars 40. Each temple bar 40 includes a pair of wire clips 48 with outwardly turned ends 50. The temple bars 40 extend rearward and have earpieces 52 integrally formed thereon, or may optionally be separately attached thereto.

To attach the temple bars 40 to the prescription insert 10, the wire clips 48 are squeezed together and inserted into slots 44 on the temple bar mounting structures 20, respectively. The user then releases the clips 48, ensuring that the upturned ends 50 fall into the recesses 46, to secure the respective temple bar 40 to the prescription insert 10. The outwardly turned ends 50 on the clips 48 lock into the recesses 46 on the interior of the slots 44 of the temple bar mounting structure 20 to prevent the temple bars 20 from coming loose from the prescription insert 10.

Each temple bar 40 includes an inwardly swinging hinge 53 to allow the temple bar 40 to be folded so that the eyeglasses 38 may be more conveniently stored while not in use. As can be appreciated, the temple bars 40 and temple bar mounting structures 20 can be easily configured in other numerous ways to be selectively releasable.

The nose pad structure 42 has a pair of nose pads 54 connected to an arched frame 56. Preferably the nose pads 54 are pivotally attached to the arched frame 56 to allow for the pivotal adjustment of the nose pads 54 while the eyeglasses 38 are placed on the user's face. The top of the arched frame 56 of the nose pad structure 42 is fitted within the mounting slot 18 of the nose bridge support 16 to support the eyeglasses 38 on the user's face and thereby increase the comfort for the user.

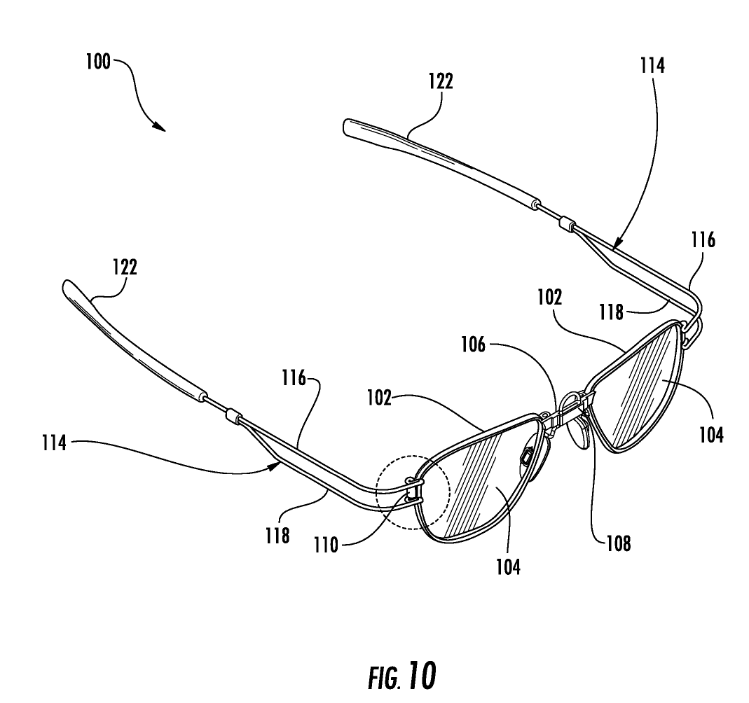

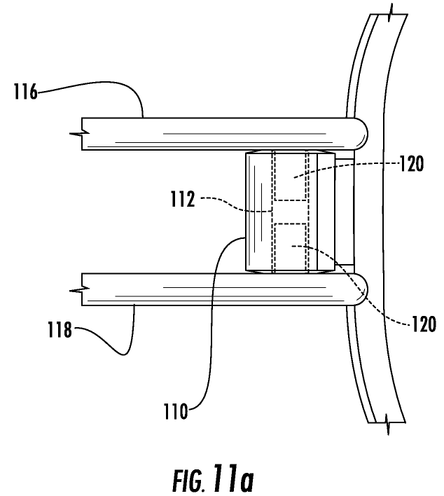

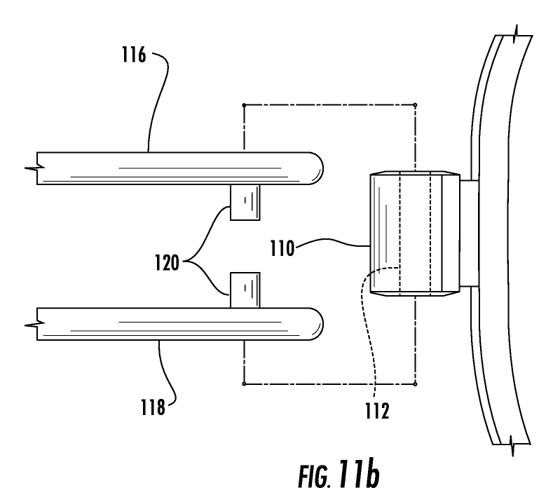

Referring to FIG. 10, an alternative embodiment of the prescription insert and conversion kit of the present invention is shown generally at 100. Like the preferred embodiment 10, the alternative prescription insert 100 includes two wire frame openings 102 to securely hold left and right lenses 104 respectively. The frames 102 are held together by nose bridge support 106 that has a central mounting slot 108 for mounting the alternative prescription insert 100 in a goggle and insert the separate nose pad structure 42 as shown in the preferred embodiment 10. At either outermost edge of the wire frame openings 102 of the alternative prescription insert 100, are left and right temple bar mounting structures 110. However the left and right temple bar mounting structures 110 are formed differ from those of the preferred embodiment 10 in that they have a central bore 112 formed therethrough, which is critical to the attachment of the temple bars 114 (seen most clearly in FIG. 11b).

The conversion kit for the alternative prescription insert 100 includes left and right temple bars 114. Each temple bar 114 includes an upper and a lower portion 116, 118 with inwardly turned ends 120. The temple bars 114 extend rearward and have earpieces 122 integrally formed thereon, or may optionally be separately attached thereto.

Referring to FIG. 11b, to attach the temple bars 114 to the alternative prescription insert 100, the upper and lower portion 116, 118 of each temple bar 114 are forced apart and the inwardly turned ends 120 are inserted into the open ends of the central bore 112 on the temple bar mounting structures 110, respectively. The user then releases the upper and lower portion 116, 118 of the temple bar 114 to. The inwardly turned ends 120 on the temple bar 114 lock into the open ends of the central bore 112 on the temple bar mounting structures 110 to prevent the temple bars 114 from coming loose from the alternative prescription insert 100. Although a central bore 112 is preferred for the attachment of the temple bars 114 to the alternative embodiment 100, a pair of shallow recesses could be formed and would work equally well.

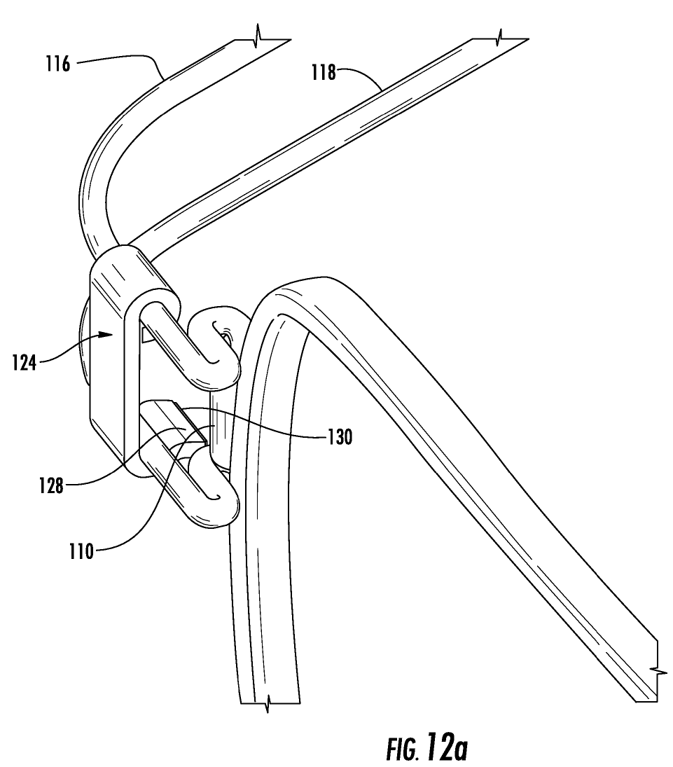

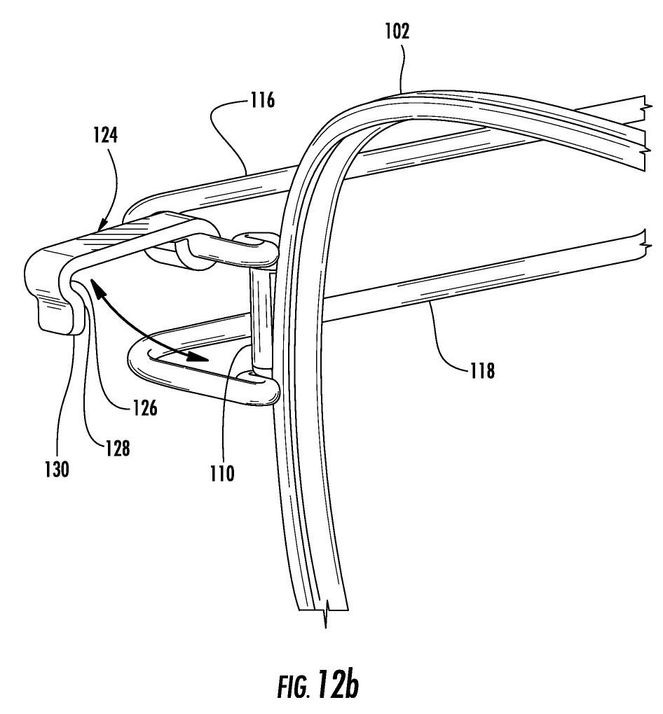

Referring to FIGS. 12a and 12b, a clasp 124 may be included on the temple bar 114 to help prevent the temple bar 114 from accidentally releasing from the alternative prescription insert 100 of the present invention. In particular, one end of the clasp 124 is pivotally mounted to the upper portion of the temple bar 114. The other end of the clasp is configured and arranged to be snap-received over the lower portion 118 of the temple bar 114 thereby preventing the inwardly turned ends 120 from being dislodged from the central bore 112 of the temple bar mounting structure 110. In particular, the other end of the clasp 124 has a surface that forms a pocket 126 for the lower portion 118 of the temple bar 114, a raised shoulder 128 to prevent the lower portion 118 of the temple bar 114 from riding out of the pocket 126, and a release portion 130 to allow the user to easily pry the clasp 124 free from the lower portion 118 of the temple bar 114. As can be appreciated by one skilled in the art, the arrangement may be reversed in that the clasp 124 may be pivotally mounted to the lower portion 118 of the temple bar 114 and configured to be secured to the upper portion 116 of the temple bar 114.

Therefore, it can be seen that the present invention provides a unique solution to the problem of providing a prescription insert that can be universally mounted within a variety of protective eyewear and masks and a prescription insert that can be easily converted into a functional pair of eyeglasses.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. A kit for an optical insert for a pair of protective eyewear, comprising:
an optical insert having a frame and a nose bridge support, said frame including a left lens opening and a right lens opening, said left lens opening and said right lens opening being configured and arranged to receive a left lens and a right lens, respectively, said nose bridge support connecting said left lens opening and said right lens opening of said frame together, said nose bridge support having a surface defining a central mounting slot therethrough,
at least one mounting structure having a forward facing portion and a rearward facing portion, said forward facing portion having means for coupling to said eyewear, said rearward facing portion having means for coupling to an optical insert; and
said central mounting slot being vertically orientated and configured and arranged to cooperate with said forward facing portion of said at least one mounting structure to releasably couple the optical insert thereto.

2. The kit of claim 1, wherein said left lens and said right lens are prescription lenses.

3. The kit of claim 1, further comprising:
a left temple bar configured and arranged to releasably couple to a left side of said frame of said optical insert; and
a right temple bar configured and arranged to releasably couple to a right side of said frame of said optical insert.

4. The kit of claim 1, further comprising:
a nose pad structure having a pair of nose pads, said nose pad structure configured and arranged to releasably couple to said nose bridge support of the optical insert.

5. The kit of claim 4, wherein said nose pad structure further comprises an arched frame configured and arranged to interfit within said central mounting slot on said nose bridge support of said optical insert.

6. The kit of claim 3, wherein the optical insert further comprises:
a left temple bar mounting structure having a surface defining a pair of recesses, said left temple bar mounting structure extending from said left side of said frame; and
a right temple bar mounting structure having a surface defining a pair of recesses, said right temple bar mounting structure extending from said right side of said frame,
said left temple bar including a first pair of wire clips having turned ends extending from an end thereof, said first pair of wire clips configured and arranged to cooperate with said left temple bar mounting structure such that said turned ends of said first pair of wire clips selectively engage said pair of recesses on said left temple bar mounting structure to releasably secure said left temple bar to said left temple bar mounting structure,
said right temple bar including a second pair of wire clips having turned ends extending from an end thereof, said second pair of wire clips configured and arranged to cooperate with said right temple bar mounting structure such that said turned ends of said second pair of wire clips selectively engage said pair of recesses on said right temple bar mounting structure to releasably secure said right temple bar to said right temple bar mounting structure.

7. The kit of claim 6, further comprising:
a left hinge connected to the left temple bar configured and arranged to permit the left temple bar to fold inwardly; and
a right hinge connected to the right temple bar, the right hinge configured and arranged to permit the right temple bar to fold inwardly.

8. The kit of claim 1, wherein said forward facing portion of said mounting structure comprises:
at least one pair of hooks configured and arrange to be releasably snap-received with said protective eyewear.

9. The kit of claim 1, wherein the rearward facing portion of said mounting structure comprises a vertically projecting prong.

10. The kit of claim 1, wherein:
said rearward facing portion of said mounting structure comprises a prong, a narrow neck portion depending from the prong, and
said forward facing portion of said mounting structure comprises a pair of spaced-apart hooks depending from the neck portion configured and arranged to be releasably snapped received with said protective eyewear.

11. The kit of clam 6, wherein said turned ends are outwardly turned

12. The kit of clam 6, wherein said turned ends are inwardly turned.

13. An optical insert for a pair of protective eyewear, comprising:
a frame having a left lens opening and a right lens opening, said left lens opening and said right lens opening being configured and arranged to receive a left lens and a right lens, respectively; and
a nose bridge support connecting said left lens opening and said right lens opening of said frame together, said nose bridge support having a surface defining a central mounting slot therethrough,
said central mounting slot being vertically oriented.

14. The optical insert of claim 13, wherein said left lens and said right lens are prescription lenses.

15. The optical insert of claim 13, further comprising:
a left temple bar configured and arranged to releasably couple to a left side of sad frame of said optical insert; and
a right temple bar configured and arranged to releasably couple to a right side of said frame of said optical insert.

16. The optical insert of claim 13, further comprising:
a nose pad structure having a pair of nose pads, said nose pad structure configured and arranged to releasably couple to said nose bridge support of said optical insert.

17. The optical insert of claim 16, wherein said nose pad structure further comprises an arched frame configured and arranged to interfit within said central mounting slot on said nose bridge support of said optical insert.

18. The optical insert of claim 15, further comprising:
a left temple bar mounting structure having a surface defining a pair of recesses, said left temple bar mounting structure extending from said left side of said frame; and
a right temple bar mounting structure having a surface defining a pair of recesses, said right temple bar mounting structure extending from said right side of said frame,
said left temple bar including a first pair of wire clips having turned ends extending from an end thereof, said first pair of wire clips configured and arranged to cooperate with said left temple bar mounting structure such that said turned ends of said first pair of wire clips selectively engage said pair of recesses on said left temple bar mounting structure to releasably secure said left temple bar to said left temple bar mounting structure,
said right temple bar including a second pair of wire clips having turned ends extending from an end thereof, said second pair of wire clips configured and arranged to cooperate with said right temple bar mounting structure such that said turned ends of said second pair of wire clips selectively engage said pair of recesses on said right temple bar mounting structure to releasably secure said right temple bar to said right temple bar mounting structure.

19. The optical insert of claim 18, wherein:
said left temple bar further includes a left hinge configured and arranged to permit said left temple bar to fold inwardly; and
said right temple bar further includes a right hinge configured and arranged to permit said right temple bar to fold inwardly.

20. The kit of clam 16, wherein said turned ends are outwardly turned

21. The kit of clam 16, wherein said turned ends are inwardly turned.

22. A mounting structure for coupling an optical insert to a pair of safety eyewear, comprising:
a forward facing portion having means for coupling to the eyewear; and
a rearward facing portion having means for coupling to the optical insert.

23. The mounting structure of claim 22, wherein said forward facing portion comprises:
at least one pair of hooks configured and arrange to be releasably snap-received with said protective eyewear.

24. The mounting structure of claim 22, wherein the rearward facing portion comprises a prong.

25. The mounting structure of claim 22, wherein:
said rearward facing portion comprises a prong, a narrow neck portion depending from the prong, and
said forward facing portion comprises a pair of spaced-apart hooks depending from the neck portion configured and arranged to be releasably snapped received with said protective eyewear.
